(19) United States
(12) Patent Application Publication
(10) Pub. No.: US 2008/0252433 A1
(43) Pub. Date: Oct. 16, 2008

(54) Vehicle Driving Aid and Method and Improved Related Device

(75) Inventors: Manuel Yguel, Grenoble (FR); Kamel Mekhnacha, Grenoble (FR); Christian Laugier, Grenoble (FR)

Correspondence Address: YOUNG & THOMPSON, 209 Madison Street, Suite 500, ALEXANDRIA, VA, 22314, US

(73) Assignees: INSTITUT NATIONAL DE LA RECHERCHE EN INFORMATIQUE ET EN AUTOMATIQUE, Le Chesnay (FR); PROBAYERS, Montbonnot St. Martin (FR)

(21) Appl. No.: 12/066,265

(22) PCT Filed: Sep. 8, 2006
(86) PCT No.: PCT/FR06/50860

§ 371 Date: Jun. 5, 2008

(30) Foreign Application Priority Data
Sep. 9, 2005 (FR) 0552736

(51) Int. Cl. B60Q 1/00

(52) U.S. Cl. 340/435

(57) ABSTRACT

A vehicle driving aid method includes and defining an occupation grid corresponding to discretization into N cells of a field of kinematic parameters of a detected object; acquiring at each time k an observation z^{k} produced by a sensor and determining a sensor probability modeling the behavior thereof; calculating for each cell X, a predicted occupation probability providing the probability that the cell X is, at time k, in occupied state having knowledge of a density of estimated of occupation of the grid a the preceding time; calculating for each cell X, an estimated probability of occupation providing the sensor probability and predicted occupation probability; the latter at time k determined by supposing that a single cell of the grid constitutes, at time k−1, the antecedent of the cell X concerned; evaluating, for each cell X, a collision probability, based on the estimated probability at time k and emitting a signal to avoid the object.

The invention relates to the field of vehicle driving aid. More particularly, the invention relates to an aid function making it possible to anticipate collisions between the vehicle and objects present in the surroundings of said vehicle.

Today's vehicles have driving aid functions available to compensate for possible driving errors. For example, ABS (Anti-Lock Braking System) function makes it possible to limit wheel slip, and consequently to reduce braking distance. The final purpose of these aid functions is to reduce road insecurity.

On this account, attempts have been made to develop functions for maintaining a security distance between two vehicles. Thus, some vehicles are equipped with an ACC (“Adaptive Cruise Control”) system. This system helps to detect the vehicle in front of the vehicle equipped with a laser or a camera, to estimate the speed and distance of the preceding vehicle, and then to control speed of said equipped vehicle in order to maintain the security distance.

However, the ACC system can be used only on motorways, when driving conditions are simple.

Therefore, there is a need for an aid function making it possible to avoid collisions and working in a complex environment, particularly in an urban environment. Indeed, in the latter case, the vehicle has a chance to collide with various objects, which are sometimes vulnerable and which have an unpredictable behavior. In particular, an object can be temporarily hidden by another object of the scene. For example, it may be a pedestrian concealed behind a parked vehicle.

To address this problem, studies have been concentrated on a method of multitracking enabling the maintenance of a list of tracks, each of which represent an object supposed to be present in the surroundings. After each new series of observations, the following steps have to be performed: associating the new measurements with the existing tracks; modifying the list of tracks by creating, confirming or deleting a track; predicting the instant state of each track by mean of a Kalman type filter; and applying a window to associate with a track the observations to come around the estimated state of this track.

However, this multitrack method suffers from reliability problems, in particular in the steps of associating and modifying the list of tracks. Further, when representing the surroundings by mean of a list Of tracks, a great quantity of the available information is lost. For example, multitrack method does not enable to keep information about areas of the surroundings that are hidden by an object.

An object of the invention is to provide an aid function making it possible to anticipate collisions, which can be implemented in a complex environment. Another object of the invention is to address the above mentioned drawbacks and, particularly, to take into account hiding of objects. For the invention to be effectively installed onboard a vehicle, objects of the scene must be taken into account as accurately as possible, by limiting as much as possible errors on the presence of an object at a given place of the scene. The invention must also be able to be implemented nearly in real time, in order to take into account fast modifications of the scene.

The invention will be better understood and other purposes, details, features and advantages of the invention will become more clearly apparent from the description which is given merely by way of illustrative and non-limitative example with reference to the appended drawing.

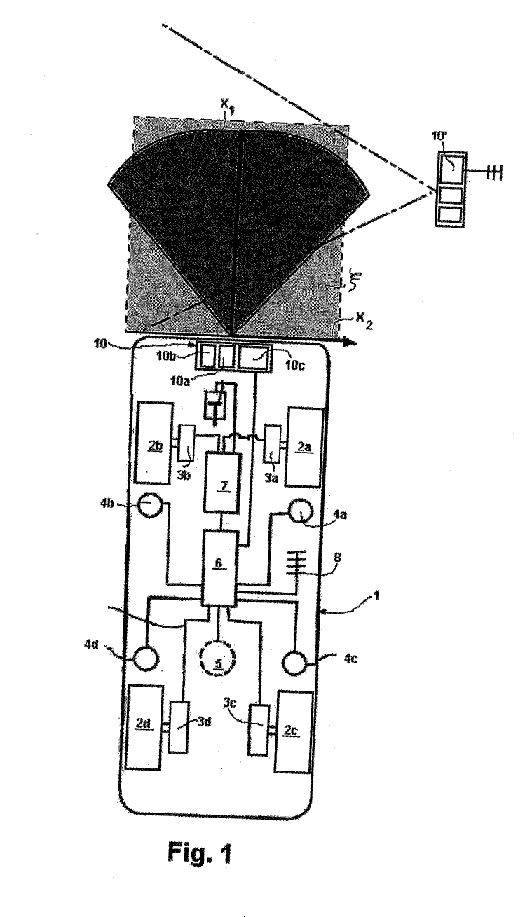

FIG. 1 shows a schematic illustration of a vehicle with the driving aid device of the invention on board.

### A—GENERAL DESCRIPTION OF AN EMBODIMENT

The driving aid method of the invention is implemented in a vehicle 1 schematically shown in FIG. 1.

As well known, vehicle 1 comprises four wheels 2a-d. Front wheels 2a and 2b are, for example, driven by a heat engine. Each of wheels 2a-d is equipped with braking means 3a-d. For example, front wheels 2a and 2b are fitted with hydraulic brakes, whereas rear wheels 2c and 2d are fitted with electromechanical brakes 3c and 3d.

Vehicle 1 comprises a plurality of sensors. Speed sensors 4a-d are arranged on each wheel 2a-2d. Each speed sensor provides a measurement of the rotational speed of the wheel on which it is installed. Vehicle 1 is also equipped with an acceleration sensor 5. The different sensors deliver signals which are routed to a central processing unit 6 via a communication network (e.g., CANBus type).

Processing unit 6 comprises a processor able to execute instructions from a computer program. Processing unit 6 also comprises storage means for permanent storage of said instructions and predefined parameters, or for transient storage of the results of the calculations executed by said processor. The processing unit also comprises a clock for timing and synchronization of its operation.

Furthermore, processing unit 6 comprises input/output interfaces for reception of input signals originating from the different sensors and transmission of output control signals towards actuators.

Processing unit 6 calculates longitudinal speed of vehicle 1 from the different signals outputted by speed sensors 4a-d.

Processing unit 6 can comprise braking management functions, for example an ABS system (“Anti-lock Braking System”). Using the speed, processing unit 6 determine the slip of each wheel. When the slip of one of the wheels is greater than a predetermined threshold, processing unit 6 produces a brake actuation signal to reduce the slip of said wheel. This additional braking is not at all controlled by the vehicle driver, for whom this operation is totally transparent.

According to the invention, vehicle 1 is equipped with at least one sensor for detecting the presence of objects. Different types of sensor can be used. For example, sensor 10 shown in FIG. 1 is a laser telemeter. It helps to detect objects present in a “field of view” or corresponding detection area, in a horizontal plane, to a cone having a total opening angle φ₀ of 90°, to a depth p₀ of approximately 20 m forward the vehicle. As a variation of this embodiment, the sensor installed on board this vehicle could be a laser or sonar type detector, or alternatively a CCD camera. By CCD camera is meant not only the detector, but also the image preprocessing electronics which produces a signal containing useful information. For example, the preprocessing electronics is able to generate a frame around a moving object by gathering together all the points in the image which are animated with the same speed.

In FIG. 1, the sensor is shown in a front position on vehicle 1, for the detection area being in front of the vehicle. Alternatively, for example in case of a bus having large blind zones, the sensor can be arranged in such a manner to provide an aid during a reversing maneuver or during closing of the bus doors, the detection area being then behind the bus, or alternatively on its side.

In a further embodiment, sensors for detecting presence of objects can be arranged fixedly in the landscape. In FIG. 1 is shown such a sensor 10′, which can be fixed on an element of the road infrastructure, such as a bus shelter, a guard rail, a road sign or equivalent. Sensor 10′ is fitted with transmission means which, either directly or by the way of relays, provide transmission of a detection signal to vehicle 1. Having reception means, as schematically represented by antenna 8, vehicle 1 is able to put the detected object into its own referential. To determine its position and speed relative to sensor 10′, vehicle 1 comprises positioning means of GPS type, with possibly local positioning beacons.

The laser telemeter comprises a source 10a emitting a directional beam. In a time period indexed by an integer k and with a sampling period of about 10 ms, the beam scans the opening cone φ₀. Part of the energy of the emitted beam is reflected by an object toward vehicle 1. A receiver 10b detects the reflected beam. Data acquisition electronics 10c of sensor 10 determines distance p and angular position Φ of the detected object. A laser telemeter does not allow a speed measurement. That is why acquisition electronics can potentially execute a preprocessing step enabling estimation of a value of the detected object speed, using for example a nearest neighbor algorithm between two successive measurements of the depth and the angular position of the detected object. Sensor 10 finally output a signal corresponding to a measurement of position, and possibly of speed, of the detected object at time k.

Measurements are obtained relative to the referential of vehicle 1. In case of a fixed sensor installed in the landscape, such as sensor 10′, positioning data of an object are sent to vehicle 1, which can determine the position of the detected object in a simple manner by referential changing, based on its position, speed and acceleration relative to the fixed sensor, these dynamic values being obtained as mentioned above using a GPS positioning system.

The measurement taken by sensor 10 is sent to input of processing unit 6 via communication lines. Then, processing unit 6 execute instructions from the software part of the invention, with a period equal to the sampling period of the sensor, namely Δt=10 ms.

The execution of these instructions makes it possible, at each time k, first to calculate the probability that a space area is occupied by an object, and next to associate a hazard level with this occupied space area.

To avoid collision, information corresponding to the hazard level can be used in the form of visual and/or audible alarm indicating the presence of the object to the driver, or in the form of a brake actuation control to reach a target speed enabling avoidance of the detected danger.

The software part of the invention needs to be executed entirely during the Δt period, i.e. nearly in real time. As a result, constraints are imposed on the algorithm of the present invention, given the currently available computing power. Typically, processing unit 6 is fitted with a 2 GHz Pentium IV-type processor and 100 Go of storage capacity.

### B—NOTION OF OCCUPANCY GRID

The spatial domain ξ in which to determine the presence of an object corresponds to a rectangular area in front of vehicle 1. This two-dimensional area is indexed by Cartesian coordinates: X₁ in longitudinal direction and X₂ in transversal direction.

This spatial domain ξ is scanned to give a grid G. It is divided into cells having a predetermined regular pitch ΔX₁ in X₁-direction and ΔX₂ in X₂-direction. So it is a regular and static discretization of the surroundings of the vehicle, as a set of N cells X (X₁, X₂). The two-dimensional grid currently used contains approximately 100 000 cells. In the embodiment of FIG. 1, its span is typically 20 nm in X₁-direction by 20 m in X₂-direction. As shown in FIG. 1, the spatial domain ξ does not overlap exactly the detection area covered by sensor 10.

An occupancy grid is then obtained by associating with each cell of the grid a number representing the probability that this cell is occupied by an object.

It is then desired to determine the probability that the cell x is in the occupied state E^{k}ₓ=1 at time k, considering the series of observations z⁰ . . . z^{k} carried out over time. This probability of occupancy is denoted by P(E^{k}ₓ|z⁰ . . . z^{k}x). As usual in probability theory, P(A|B) denotes the probability of A given B. It should be noted that “observation z^{k}” is not directly the measurement at p and Φ given by the sensor, but rather corresponds to this measurement related to the cell: if a measurement indicates the presence of an object at p and Φ, z^{k} equals 1 for the cell x^{k} associated with the coordinates p and Φ, and equals 0 otherwise.

The state Eₓ of a cell of the grid is assumed independent from the other cells, and particularly from the neighboring cells. This assumption aims to reduce the correlations between cells, and therefore to simplify calculation of the probability of occupancy over the set of N cells X of the grid G. In fact, it amounts to repeating N times the calculation providing estimation of the probability of occupancy for a single cell.

Advantageously, the algorithm of the invention is coded in such a manner to be totally parallelizable. It can be implemented by an electronic board having N processors working in parallel, where each processor calculates the probability of occupancy for the cell of the grid it represents.

The algorithm of the invention is schematically divided into several modules:
the first module consist in modeling the sensor response. The “sensor model” is based on a distribution of probabilities p(Z^{k}|E^{k}ₓX) which indicates the probability for the observation Z^{k} knowing state E^{k}ₓ of cell X at time k. It should be noted that upper-cases indicate a variable which can takes a set of possible values denoted by lower-cases. By instantiation of a variable A, it should be understood the particular value a taken by the variable A;

the second module is a prediction module. It provides prediction of state E^{k}ₓ of cell X at time k, given the state of the grid at time k−1;

the third module is an estimation module providing calculation of the probability of occupancy E^{k}ₓ of cell X at time k, based on observations Z^{k} at time k and on the result of the prediction step obtained at output of the second module;

finally, a fourth module associates a quantity indicating a hazard of collision with the cells of the grid whom the probability of occupancy is high, and outputs an appropriate signal.

### C—MODEL OF A TELEMETRIC SENSOR

Information collected by the sensor has a limited accuracy. Many factors affect the accuracy of the measurement: temperature, lighting, color of the object, etc. To exploit measurements as fully as possible, it is important to take into account the noise of the observed quantity. According to the invention, the sensor response is described by a probabilistic model specified as a Bayesian program.

Pertinent variables of the problem are: observation Z; cell X; variable E_{X} denoting that an object exists in cell X; and variable D_{X} denoting that an object has been detected in cell X.

Conjunction of the variables E_{X} and D_{X} enables to explicit the four possible following situations:

[E_{X}=1]̂[D_{X}=1]: an object is effectively in cell X, and it has been detected by the sensor;

[E_{X}=0]̂[D_{X}=0]: the cell is empty, and the sensor effectively does not detect anything in it;

[E_{X}=1]̂[D_{X}=0]: an object is in cell X, but it is not detected by the sensor. It is for example the case when cell X is out of the detection area of the sensor, when cell X is hidden by another object, or when the sensor is defective;

[E_{X}=0]̂[D_{X}=1]: the cell is empty, and yet the sensor detects an object in it.

These last two situations correspond to a failure of the sensor.

The conditional probability P(Z,X,E_{X},D_{X}), which expresses the conjunction of the different selected variables, is advantageously divided in P(X) and P(Eₓ|X) representing an a priori knowledge about the surroundings of the vehicle. In a first time, in order not to favor any particular situation, these distributions are chosen to be uniform. However, as will be explained thereafter, P(E_{X}|X) allows to take into account the scene history.

Probability P(Dₓ|EₓX) represents the sensor ability to detect or not a target, or to generate false alarms:

P([D_{X}=1]|[E_{X}=1],X)=P_{D}(X) represents the probability of detection.

P([D_{X}=0]|[E_{X}=1],X)=1−P_{D}(X) represents the probability that the sensor fails to detect an existing target.

P([D_{X}=1]|[E_{X}=0],X)=P_{FA}(X) represents the probability of false alarm.

P([D_{X}=0]|[E_{X}=0],X)=1−P_{FA}(X).

These probability distributions depend on the sensor and on the conditions in which it is used. P_{D}(X) and P_{FA}(X) can be estimated from a modeling of the physical characteristics of the sensors and of the detected objects. They can also be “learned” through experiments in the particular conditions of use of the sensor during a first calibration step.

The different parametric forms associated with the distribution family P(Z|D_{X},E_{X},X) remain to be set according to the values of D_{X} and E_{X}.

P(Z|[D_{X}=1][E_{X}=0],X) and P(Z|[D_{X}=1][E_{X}=1],X) indicate that a detection occurred in cell X. It is another formulation of the likelihood function of the sensor. Most often, a family of normal distributions is used:

P(Z|[D_{X}=1]E_{X}X)=N(Z,μ(X),Σ(X)).

where, for a given value of X, the mean μ(X) of the normal distribution represents the expected response of the sensor. The covariance matrix Σ(X) enables representation of the possible variations of the sensor response around the expected response. In this way, it represents the sensor accuracy. The parameters of the sensor model, as the mean and the covariance matrix in the Gaussian case, can be obtained during a second sensor calibration step.

P(Z|[D_{X}=0][E_{X}=0],X) indicates that cell X is empty and that nothing has been detected in this cell. Considering only these information, it is difficult to say what can be the value of observation Z in another cell. A uniform distribution is chosen.

P(Z|[D_{X}=0][E_{X}=1],X) indicates that cell X is occupied by an object and that nothing has been detected. Either an object hides cell X and has been detected by the sensor, or the object present in cell X is not hidden and has not been detected. It is decided that the probability for the measurement Z to be in an area hidden by cell X is different from the one of the non hidden areas.

Given the parameters of the model, the above description can be used to calculate the sensor probability:

$$\begin{matrix}P ( Z \vert {e}_{x} x ) = \frac{{\sum }_{{D}_{X}} P ( {Zxe}_{x} {D}_{X} )}{P ( {e}_{x} x )} \\ = \frac{P ( x ) P ( {e}_{x} \vert x ) {\sum }_{{D}_{X}} P ( {D}_{X} \vert {e}_{x} x ) P ( Z \vert {D}_{X} {e}_{x} x )}{\underbrace{P ( x ) P ( {e}_{x} \vert x ) {\sum }_{Z , {D}_{X}} P ( {D}_{X} \vert {e}_{x} x ) P ( Z \vert {D}_{X} {e}_{x} x )}_{= 1}} \\ = {\sum }_{{D}_{X}} P ( {D}_{X} \vert {e}_{x} x ) P ( Z \vert {D}_{X} {e}_{x} x ) .\end{matrix}$$

### D—EQUIVALENT OCCUPANCY GRID AND COMPRESSION

In the present embodiment of the invention, the occupancy grid is a spatial grid. Accordingly, for each value of speed (two dimensions), a two-dimensional occupancy grid must be stored. Therefore, a large number of data need to be stored to give an accurate representation of the surroundings. i.e. to monitor wide areas of the surroundings with a fine discretization pitch in order to distinguish the objects therein. Besides the question of the required storage capacity, the data processing speed is a critical parameter in a real time application.

According to the invention, a data structure representing the occupancy grid but having a reduced storage capacity is used.

In a first time, how the probability of occupancy of a cell is updated at time k based on a new observation will be described. Let Z be a random variable whose set of possible events corresponds to the set of possible measurements of a sensor. Let P(Z|Eₓ) be the conditional probability distribution over Z, given the occupancy state Eₓ of the considered cell x. Conjunct distribution is then P(Z, Eₓ)=P(Eₓ) P(Z|Eₓ), where p(Eₓ) corresponds to an a priori about cell x being occupied.

For a new measurement z^{k} and an occupancy value eₓ of cell x, Bayes' rule give:

$$p ( {e}_{x} \vert {z}^{k} ) = \frac{p ( {e}_{x} ) p ( {z}^{k} \vert {e}_{x} )}{p ( {z}^{k} )}$$

with: p(z^{k})=p(eₓ=1)p(z^{k}|eₓ=1)+p(eₓ=0)p(z^{k}|eₓ=0)

Updating the probability of occupancy of cell x corresponds to:

$${p}_{k + 1} ( {e}_{x} ) = p ( {e}_{x} \vert {z}^{k} ) = \frac{{p}_{k} ( {e}_{x} ) p ( {z}^{k} \vert {e}_{x} )}{{\sum }_{{e}_{x}} {p}_{k} ( {e}_{x} ) p ( {z}^{k} \vert {e}_{x} )}$$

When constructing an occupancy grid, series of observations \vec{Zₖ}={z⁰, z¹, . . . , z^{k}} is detected by the system, and pₖ(eₓ)==p(eₓ|z⁰, z¹, . . . , z^{k-1}) is noted.

This updating chain is used with the initial distribution chosen uniform, since no information about the surroundings is available a priori.

As variable Eₓ is binary, the following relation is obtained: pₖ(eₓ=1)=1−pₖ(eₓ=0). It is then equivalent to store in memory, for each cell of the grid, the variable qₖ defined by:

$${q}_{k} = \frac{{p}_{k} ( {e}_{x} = 1 )}{{p}_{k} ( {e}_{x} = 0 )} .$$

By injecting relation (1) in the above definition, the recursive relation is obtained:

$${q}_{k} = \frac{p ( {z}^{k - 1} \vert {e}_{x} = 1 )}{p ( {z}^{k - 1} \vert {e}_{x} = 0 )} {q}_{k - 1} = {q}_{0} {\prod }_{i = 0}^{k - 1} \frac{p ( {z}^{i} \vert {e}_{x} = 1 )}{p ( {z}^{i} \vert {e}_{x} = 0 )}$$

Advantageously, the logarithm of variable qₖ can be taken into account in order to transform the product in a sum, in the following relation:

$$log ( {q}_{k} ) = log ( {q}_{0} ) + {\sum }_{i = 0}^{k - 1} \frac{p ( {z}^{i} \vert {e}_{x} = 1 )}{p ( {z}^{i} \vert {e}_{x} = 0 )} .$$

Updating of variable log(qₖ) for a given cell x, and therefore updating of an equivalent occupancy grid (each cell of this new grid having the numerical value of log(qₖ), is then a simple addition operation at each temporal step.

Using variable log(qₖ) is advantageous because it is then easy to compress the equivalent occupancy grid by executing a wavelet transform, for example by mean of Haar wavelets, and eliminating coefficients having a low magnitude. The notion of wavelet transform is widely described in literature and is the subject of numerous publications, both scientific and popularization works. It should be noted that, advantageously, the space of the signals transformed in wavelets is a vector space, which as such is stable by the operations of addition and multiplication by a scalar quantity. Further, the wavelet transform is a linear operation relative to the number of data, whereby a fast execution of the compression algorithm is assured.

Following algorithm is currently suggested to implement this wavelet compression of the equivalent occupancy grid:

obtaining data from the sensor at time k for the complete field of view;

in the field of view, constructing the grid of logarithms

$$log ( {q}_{k} ( x ) ) = \frac{p ( {z}^{k - 1} \vert {e}_{x} = 1 )}{p ( {z}^{k - 1} \vert {e}_{x} = 0 )} ;$$

finding the maximum Haar scale function support squares c completely included in the field of view of the sensor;
executing a wavelet transform of function log(qₖ(x)) to each square previously found: W_{c};

adding each W_{c} to the global Haar occupancy grid;

if the number of coefficients is too large, executing a non linear compression by eliminating all the coefficients whose norm is negligible relative to the norm of the complete representation.

### E—MULTIPLIER CASE

Using several sensors to increase the robustness of the observations is advantageous. It is therefore possible to eliminate limitations peculiar to each sensor (for example, a laser sensor works poorly when it rains), to restrict dependence on faults of a sensor (it is possible to use several sensors of the same type), and especially to increase the accuracy of detection of an object in the surroundings by using the information redundancy.

When S sensors are used, each of which enabling a measurement zk at time k, it is assumed that, the state of a cell being known, the observations of the several sensors are independent.

So, the conjunct probability is divided as following:

$$P ( {Z}_{1} … {Z}_{S} {XE}_{X} ) = P ( X ) P ( {E}_{X} \vert X ) {\prod }_{s = 1}^{S} P ( {Z}_{s} \vert {E}_{X} X ) .$$

where P(Zᵢ|E_{X},X) is the model of the i-th sensor as described in details above.

Given a series of observations at time k, Z₁ . . . Z_{S}, the probability that cell X is occupied becomes:

$$P ( {E}_{x} \vert {z}_{1} {…z}_{s} x ) ℒP ( {E}_{x} \vert x ) {\prod }_{s = 1}^{S} P ( {z}_{s} \vert {E}_{x} x )$$

### F—OCCUPANCY GRID AND BAYESIAN FILTERS

According to the invention, the modules of prediction and estimation of a probability of occupancy at time k implement the notion of Bayesian filter applied to occupancy grids. A Bayesian filter enables prediction of the temporal evolution of a system. The purpose is here to give robustness to the occupancy grid, enabling it to take into account a fault of a sensor or a temporary hiding of an object in the hazard evaluation.

In broad outline, it is desired to estimate recursively the probability of occupancy of a cell at time k. This is done in two steps: a prediction step whose purpose is to estimate a priori the occupancy state of the cell; and an estimation step whose purpose is to calculate the probability of occupancy by taking into account the a priori estimation and the instantaneous observation.

The considered variables are:

X that specifies which is the processed cell;

E^{k}_{X} that represents the state of cell X at time k;

z⁰, . . . , z^{k}=z^{0:k} that represent the series of observations from an initial time.

For the prediction step, it is shown that the probability of prediction is expressed by:

$$P ( {E}_{X}^{k} , X \vert {z}^{0 \text{:} k - 1} ) = {\int }_{( {E}_{X}^{k - 1} , {X}^{′} )} P ( {E}_{X}^{k} , X \vert {E}_{{X}^{′}}^{k - 1} , {X}^{′} ) P ( {E}_{{X}^{′}}^{k} , {X}^{′} \vert {z}^{0 \text{:} k - 1} ) \qquad ( 2 )$$

where P(E_{X}^{k},X′|z^{0:k-1}) is the estimated probability of occupancy of cell X′ at time k−1; where P(E_{X}^{k},X|E_{X′}^{k-1},X′) is the probability of transition from any intermediate state (E_{X′}^{k-1},X′) of the system at time k−1 to the considered state (E_{X}^{k},X), i.e. it corresponds to the dynamic model of the system; and where the sum is calculated over the set of possible intermediate states (E_{X′}^{k-1},X′).

For the estimation step, it is shown that the probability of prediction is expressed by:

$$P ( {E}_{X}^{k} , X \vert {z}^{0 \text{:} k} ) = \frac{1}{α} P ( {z}^{k} \vert {E}_{X}^{k} , X ) P ( {E}_{X}^{k} , X \vert {z}^{0 \text{:} k - 1} ) \qquad ( 3 )$$

where the probability of the sensor model p(Z^{k}|E^{k}_{X},X) and the probability of prediction at time k: P(E^{k}_{X},X|z^{0:k-1}) appear.

These two equations enable a structure of the prediction/estimation loop type.

### G—NON CONTINUOUS DISCRETIZATION OF THE DIMENSIONS OF SPEED

The above described is easily transposable to an occupancy grid of more than two dimensions. It is possible to construct a four-dimensional grid, having the both spatial dimensions X₁ and X₂ as described above, to which are added two dimensions of speed X′₁ and X′₂. If the sensor does not directly give a measurement of the speed of the detected object, this speed can be calculated from the variation of the spatial position of the object, for example X′₁=Δx₁/Δt and X′₂=Δx₂/Δt, by taking as time interval Δt the sampling time of the sensor between two successive measurements of the position of the object. The dimensions of speed are then discretized in a regular and continuous manner, with a pitch ΔX′₁ in X′₁-direction and a pitch ΔX′₂ in X′₂-direction.

This approach in which the space of speed is discretized in a continuous manner presents the following problem. Let's consider a spatial grid associated with a value of speed X′₀ (X′₁₀ and X′₂₀), referred to herein as “plane of speed”. Let's consider a cell of this plane of speed occupied by an object at time k−1. If the speed X′₀ does not correspond to an integer multiple of the spatial discretization pitch ΔX divided by the time interval Δt, then, at time k, the objet does not occupy only one cell of the plane of speed, but spans over a set of cells. Now, a cell of the grid over which an object spans is considered to be occupied. At the following time interval, these occupied cells are propagated, still increasing the volume of occupied cells. Therefore, error on the state of the grid, essentially due to discretization, is amplified during the prediction step. Error on discretization is growing and is reduced only by the observation phase.

According to the invention, in a first time, the two-dimensional Cartesian space is continuously discretized, and then, in a second time, the number of possible planes of speed is limited. Are considered only plans of speed for which the speed can be expressed, according to discretization pitches Δx₁ and Δx₂ and to sampling interval Δt, by X′₁=p/n (Δx₁/Δt) and X′₂=q/n (Δx₂/Δt), with p and q belonging to the set of integers.

Therefore, authorized movements are the ones that make a cell pass exactly to another cell in a number n of times the sampling interval Δt. A plane of speed is a two-dimensional spatial grid which is associated with a triplet (p, q, n) defining a speed.

Indeed, a discretized, but not continuous, space of speed is obtained. Then, to calculate the integral over the set of cells that intervene in the determination of the predicted probability of occupancy, a constant speed is assumed. According to this assumption, between two successive times, the speed of an object is constant and the probability of transition from a plane of speed to another is null. That is, if cell X^{k-n} (X₁, X₂) of plane of speed X′ (p/n(Δx₁/Δt), q/n(Δx₂/Δt)) is occupied at time k−n, then cell X^{k} (X₁+p/nΔx₁, X₂+q/nΔx₂) is occupied at time k.

Conversely, when the predicted probability of occupancy of the cell X^{k} is calculated, for each possible plane of speed (p, q, n), only the estimated probability of occupancy at time k−n of the cell X^{k-n} that is antecedent to the cell X^{k} intervene in the calculation.

Advantageously, at each observation time, the factor 1/n enables to consider the plane of speed (p, q, n) only for a frequency 1/n. Therefore, for a plane of low speed, the integral calculation is done only for a low frequency. On the other hand, a plane in which there is a high speed object is observed at a higher frequency in order to take into account the fast evolution of the behavior of this object.

The invention is implemented as follows:

In a first time, a spatial area (2D) around a typical central cell X_{c} is delimited.

A maximum number nₘₐₓ of time steps is defined. The set of cells of that area are the ones that can reach the central cell X_{c} in 1, 2, . . . nₘₐₓ time steps.

The set of possible speeds V_{f}, denoted by (p/n(Δx₁/Δt), q/n(Δx₂/Δt)), that enable to one of the cells of that area to propagate toward central cell X_{c}, in at most nₘₐₓ time steps, is determined.

The set V_{f} is then divided into subsets of speeds enabling a cell to reach the central cell in n time steps:

$${V}_{f} = {⋃}_{j} {V}_{fi} with {V}_{fi} = \{ v = ( p , q , n ) ∈ {V}_{f} \vert n = i \}$$

Thereafter, a two-dimensional spatial grid Gⁱ_{(p,q)} is associated with each element (p, q, i) belonging to one of the V_{fi}. Then, the antecedent to a cell (l, m) of this grid is cell (l−p, m−q).

A counter k, giving the time step index, incremented by one unit for each iteration, evolves between zero and the value corresponding to the lowest common multiple of 2 and nₘₐₓ. (Indeed, the lowest common multiple has to be considered because that is a set of mutually interleaved loops). At the beginning of the process, the counter is instantiated to zero, i.e. the probability of occupancy of the cell.

Then, for i going from 1 to nₘₐₓ,

if k is equal to 0 modulo i, then, for each occupancy grid Gⁱ_{(p,q)} of a subset V_{fi}, the following steps are performed:

determining which is the cell antecedent to the considered cell;

attributing the estimated probability of occupancy given by Gⁱ_{(p,q)} for said antecedent as value of the predicted probability of occupancy for the considered cell (equation 2 above);

updating the grid by determining the estimated probability of occupancy from the predicted probability of occupancy and the sensor probability, considering the observation at this time step;

incrementing k by one unit, and returning to the beginning of the loop,

### H—MULTI-OBJECT CASE

In what precedes, only the case of a single object present in the surroundings of the vehicle has been specifically described. In the case of a complex environment, it is necessary to be able to take into account the presence of several objects in this environment.

When several objects are detected, the sensor executes O observations at time k:z^{k}₁, z^{k}₂ . . . z^{k}_{O}.

It is then introduced the variable M, known as a variable of association. M is an integer between 0 and O. If M=0, then no observation is used to update the probability of occupancy of cell X. But if M=i, then the i-th observation is used to update the probability of occupancy of cell X.

The conjunct probability is divided as following:

$$P ( {XE}_{X} MZ ) = P ( X ) P ( {E}_{X} \vert X ) P ( M ) {\prod }_{i = 1}^{O} P ( {Z}_{i} \vert {E}_{X} XM )$$

where variable M is independent from the state E_{X} and from considered cell X, P(M|Ex X)=P(M); a simplification has been made by assuming mutual conditional independence of the different observations zᵢ, given the state of the considered cell.

For observation zᵢ, if M is equal to i, the probability distribution to be considered is then the sensor model derived above; but, if M is different from i, a uniform distribution (U) is chosen.

In the present application, it is desired to determine P(Eₓ|z₁ . . . z_{O}x) which is written, using variable M:

$$P ( {E}_{x} \vert {z}_{1} … {z}_{O} x ) = \frac{1}{α} P ( {E}_{x} \vert x ) ( {U}_{x} + {\sum }_{m = 1}^{O} P ( {z}_{m} \vert [ M = m ] {E}_{x} x ) ) )$$

This relation is a static relation, which is made dynamic by introducing the estimation/prediction loop above described over a set of variables between an initial time 0 and a present time k. In particular, variable of association M^{k}, which is time indexed, enable association of one of the O^{k} observations made at time k with the estimation of the state.

In that modeling, the prediction equation stays the same as above described, but the estimation relation becomes:

$$P ( {E}_{X}^{k} {X}^{k} \vert {z}^{0 : k} ) = \frac{1}{α} {\sum }_{{M}^{k} = 0}^{{O}^{k}} ( P ( {M}^{k} ) {\prod }_{j = 1}^{{O}^{k}} P ( {z}_{j}^{k} \vert {M}^{k} {E}_{X}^{k} {X}^{k} ) ) \times P ( {E}_{X}^{k} {X}^{k} \vert {z}^{0 \text{:} k - 1} )$$

In order to avoid an object, the calculation of the probability of occupancy of a cell P(E^{k}ₓX|Z^{k}) has to be combined with a collision hazard probability P(D^{k}ₓ|E^{k}ₓX). This collision hazard is calculated using a criterion of time-to-collision. Then, regulation of the speed of vehicle becomes possible.

Though the invention has been described above by reference to a particular embodiment, the invention is not limited to this embodiment and includes all technical equivalents to the described means and their combinations that are within the scope of the invention.

1. Method for aiding the driving of a vehicle comprising at least one sensor able to deliver an output signal indicative of the presence of at least one object in a detection zone, said method comprising the steps of:
defining a grid corresponding to discretization into cells of a space of kinematic parameters of said object relative to said vehicle;
and, at each sampling time k:
determining an observation z^{k} from said output signal of the sensor;
and, for each cell x of the grid:
determining, from said observation z^{k}, the value of a sensor probability p(z^{k}|E^{k}ₓX) modeling the behavior of said sensor;
calculating an estimated value of occupancy at time k, based on the probability P(E^{k}ₓX|z^{0:k}=z⁰ . . . z^{k}) that the cell x is in state E^{k}ₓ at time k, given the observation z^{k}; said estimated value of occupancy at time k depending on said sensor probability p(z^{k}|E^{k}ₓX) and on a predicted occupancy value P(E^{k}ₓX|z^{0:k-1}=z^{k-1}) at time k;
determining said predicted occupancy value P (E^{k}ₓX|z^{0:k-1}=z⁰ . . . z^{k-1}) at time k, based on the probability that considered cell x is in state E^{k}ₓ at time k, by taking into account the observations from an initial time 0 to time k−1; said predicted occupancy value at time k being determined by approaching a relation of this type:
$$P ( {E}_{X}^{k} , X \vert {z}^{0 : k - 1} ) = {\int }_{( {E}_{X}^{k - 1} , {X}^{′} )} P ( {E}_{X}^{k} , X \vert {E}_{{X}^{′}}^{k - 1} , {X}^{′} ) P ( {E}_{{X}^{′}}^{k} , {X}^{′} \vert {z}^{0 \text{:} k - 1} )$$
in which intervene the estimated probability of occupancy at time k−1 for each of cells X′ of the grid, considering that the probability of transition from any cell to the considered cell is not null for only a cell said antecedent to said considered cell;
evaluating, for each cell of the grid, a collision hazard probability from said estimated value of occupancy at time k;
outputting a control signal to an actuator based on the collision hazard probabilities of the cells of the grid in order to avoid said detected object.

2. Method according to claim 1, characterized in that said occupancy value is equal to said probability of occupancy.

3. Method according to claim 1, characterized in that said occupancy value is compatible with a compression transform.

4. Method according to claim 1, characterized in that, being defined an occupancy grid which associates with each cell of the grid a first quantity depending on the probability of occupancy of said cell, a compression transform is applied to said occupancy grid to obtain an equivalent representation of said occupancy grid, said occupancy value being a second occupancy value associated with said equivalent representation of said occupancy grid.

5. Method according to claim 3, characterized in that the first estimated value of occupancy at time k is the logarithm of the ratio between the estimated occupancy probability at time k that the considered cell is occupied and the estimated occupancy probability at time k that the considered cell is empty.

6. Method according to claim 1, characterized in that said grid comprises more than 10 million cells.

7. Method according to claim 1, characterized in that, said grid being a spatial grid obtained by discretization of the space of positions of said object with a predefined pitch, said method comprises an additional step of determining a set of possible speeds, said possible speeds being the ones that enable to pass exactly from a cell of the grid to another cell of the grid in a finite number n of sampling steps.

8. Method according to claim 7, characterized in that a spatial grid is associated with each one of the possible speeds, and in that said steps of said method are executed for each grid taken separately from the others, a constant speed of said detected object being assumed.

9. Method according to claim 7, characterized in that said spatial grid comprises more than 1 million cells.

10. Method according to claim 1, characterized in that said sampling period is smaller than 10 ms.

11. Device for aiding the driving of a vehicle, characterized in that it comprises means able to implement the driving aid method according to claim 1.

12. Device according to claim 11, characterized in that it comprises N processors, N being the number of cells of said grid, each processor working in parallel with the other processors and calculating at each sampling time k the estimated value of occupancy of cell X it represents.

13. Method according to claim 4, characterized in that the first estimated value of occupancy at time k is the logarithm of the ratio between the estimated occupancy probability at time k that the considered cell is occupied and the estimated occupancy probability at time k that the considered cell is empty.

14. Method according to claim 2, characterized in that said grid comprises more than 10 million cells.

15. Method according to claim 2, characterized in that, said grid being a spatial grid obtained by discretization of the space of positions of said object with a predefined pitch, said method comprises an additional step of determining a set of possible speeds, said possible speeds being the ones that enable to pass exactly from a cell of the grid to another cell of the grid in a finite number n of sampling steps.

16. Method according to claim 8, characterized in that said spatial grid comprises more than 1 million cells.
